(19) United States
(12) Patent Application Publication
(10) Pub. No.: US 2010/0000804 A1
(43) Pub. Date: Jan. 7, 2010

(54) Solar vehicle

(76) Inventor: Ming-Hsiang Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,267

(22) Filed: Jul. 2, 2008

(51) Int. Cl. B60K 16/00; B60L 8/00

(52) U.S. Cl. 180/2.2; 180/65.31

(57) ABSTRACT

A solar vehicle includes a vehicle body, a solar panel mounted on the vehicle body, and a vehicle battery and a conversion device arranged inside the vehicle body. The vehicle body contains therein a vehicle load connected to the vehicle battery. The conversion device includes a conversion circuit, a power flow sensor, multiple input and output ports. The conversion circuit includes a DC bus and various converters (such as DC/DC, bi-directional DC/DC, bi-directional AC/DC converter, and inverter). The power flow sensor detects power flow received in the input ports and feeds the power to the conversion circuit for conversion. The solar panel provides electrical power from solar power generation to the conversion device, which after carrying out conversion, supplies the power through the output ports to the vehicle load and the vehicle battery. As such, the electrical power received by the input ports is subjected to conversion by the conversion device and thus output through the output ports and the power flow sensor detects the power flow of the input power to select one or more of the input ports to supply electrical power to the conversion device for conversion and supply of the power to the vehicle battery.

### FIELD OF THE INVENTION

The present invention relates to a solar vehicle, and in particular to a solar vehicle that is provided with a conversion device that is comprised of a power flow sensor and multiple power inputs and outputs to automatically determine and allow one or more of various power sources to supply electrical power to the vehicle.

### BACKGROUND OF THE INVENTION

With the advent of high fuel price era, the automobile industry develops a solar vehicle that is completely powered by electricity. Such a solar vehicle does not consume gasoline and diesel and is not environmentally conservative and removes the concerns for high expense of fuel.

However, the battery that is used to power the vehicle is of a limited capacity and the solar panel that is currently available is of poor conversion efficiency. Further, it is not possible for the solar vehicles available today to automatically determine if to use power from the battery or from the solar panel. In other words, the conventional solar vehicle is incapable of continuous supply of electrical power and has to be frequently shut down for power charging. This leads to insufficient cruising distance of the conventional solar vehicle.

Thus, the present invention is aimed to provide a solar vehicle that is capable to determine and select, among various available power sources, one or more power sources to supply electrical power to the vehicle to realize continuous supply of electrical power.

### SUMMARY OF THE INVENTION

An objective of the present invention is to provide a solar vehicle comprising a solar panel mounted to a sun-facing surface of a body of the vehicle and the a conversion device arranged inside the vehicle body and connected to the solar panel, wherein the conversion device is set in connection with a vehicle battery and a vehicle load and the conversion device is comprised of a plurality of input ports, a plurality of output ports, and a power flow sensor and wherein the vehicle battery and the vehicle load are connected to each other so that the vehicle is capable to determine and select one or more of various power sources to supply electrical power to the vehicle, thereby realizing continuous supply of electrical power and increase of cruising distance and also realizing supply of surplus power for other uses, which provides practicability and convenience.

Another objective of the present invention is to provide a solar vehicle, comprising a conversion device, which, with the addition of an input selector, an output selector, and the first and second timers, provides a feature of automatically selecting a specific input port for receiving power input and automatically selecting a specific output port to which power is supplied, and controls of the input power amount, the output power amount, the output target, the input target, the output sequence and the input sequence of the input and output ports. As such, the effectiveness of coupling the conversion device to the solar vehicle can be fully exploited, providing practicability and convenience.

To realize the above objectives, in accordance with the present invention, a solar vehicle is provided, comprising a vehicle body, at least one vehicle battery, a conversion device, and at least one solar panel. The vehicle body contains therein a vehicle load for in-vehicle electronic appliances. The vehicle battery is arranged inside the vehicle body and is connected to the vehicle load for supplying electrical power thereto. The conversion device is arranged inside the vehicle body and comprises first and second input ports for receiving inputs of electrical power, first and second output ports for supplying outputs of electrical power, a conversion circuit for conversion of the electrical power received by the input ports, and a power flow sensor, wherein the conversion circuit comprises a direct-current (DC) bus having an input side and an output side, a bi-directional AC (alternate-current)/DC converter and a DC/DC converter connected to the input side, and a DC/DC converter, a DC/AC inverter, and a bi-directional DC/DC converter connected to the output side. The second input port and the first input port, which is connectable to a utility power system, are both connected to the power flow sensor and are further and respectively in connection with the DC/DC converter and the bi-directional AC/DC converter of the input side so that power flows received by the input ports can be detected and then fed to the conversion circuit for power conversion. The DC/DC converter and the bi-directional DC/DC converter on the output side are respectively connected to the first and second output ports. The solar panel is arranged on a sun-facing surface of the vehicle body and is connected to the second input port of the conversion device to supply electrical power obtained from solar power generation thereto. The first and second output ports of the conversion device are respectively connected to the vehicle load and the vehicle battery for supplying power thereto.

As such, the electrical power received by the input ports is first subjected to conversion by the conversion circuit and then output through the output ports. The power flow sensor detects a power flow from the input ports to select one or more of the input ports that receive input from various power sources to supply electrical power to the conversion circuit, which electrical power, after being subjected to conversion by the conversion circuit, is supplied to the vehicle battery, thereby realizing continuous supply of electrical power and elimination of interruption of power supply for the vehicle, leading to increase of cruising distance and even additional supply of surplus power for other uses, and thus providing practicability and convenience.

### BRIEF DESCRIPTION OF THE DRAWINGS

The present invention will be apparent to those skilled in the art by reading the following description of preferred embodiments thereof with reference to the drawings, in which:

FIG. 1 is a schematic view illustrating a solar vehicle constructed in accordance with an embodiment of the present invention;

FIG. 2 is an exploded view of the solar vehicle in accordance with the embodiment of the present invention;

FIG. 3 is a block diagram of a conversion device in accordance with an embodiment of the present invention;

FIG. 4 is a block diagram of a conversion device in accordance with another embodiment of the present invention;

FIG. 5 is a schematic view illustrating an arrangement for supplying electrical power from an output port of the conversion device of the solar vehicle in accordance with the present invention; and

FIG. 6 is a schematic view illustrating an arrangement of using an input port of the conversion device to effect charging operation of the solar vehicle in accordance with the present invention.

### DETAILED DESCRIPTION OF THE PREFERRED EMBODIMENTS

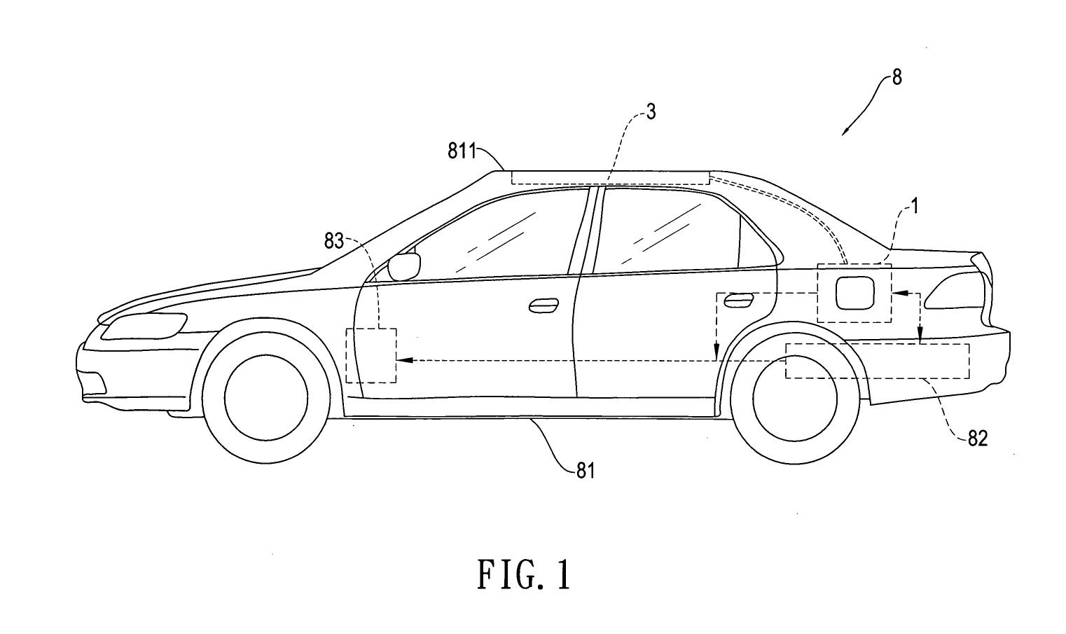

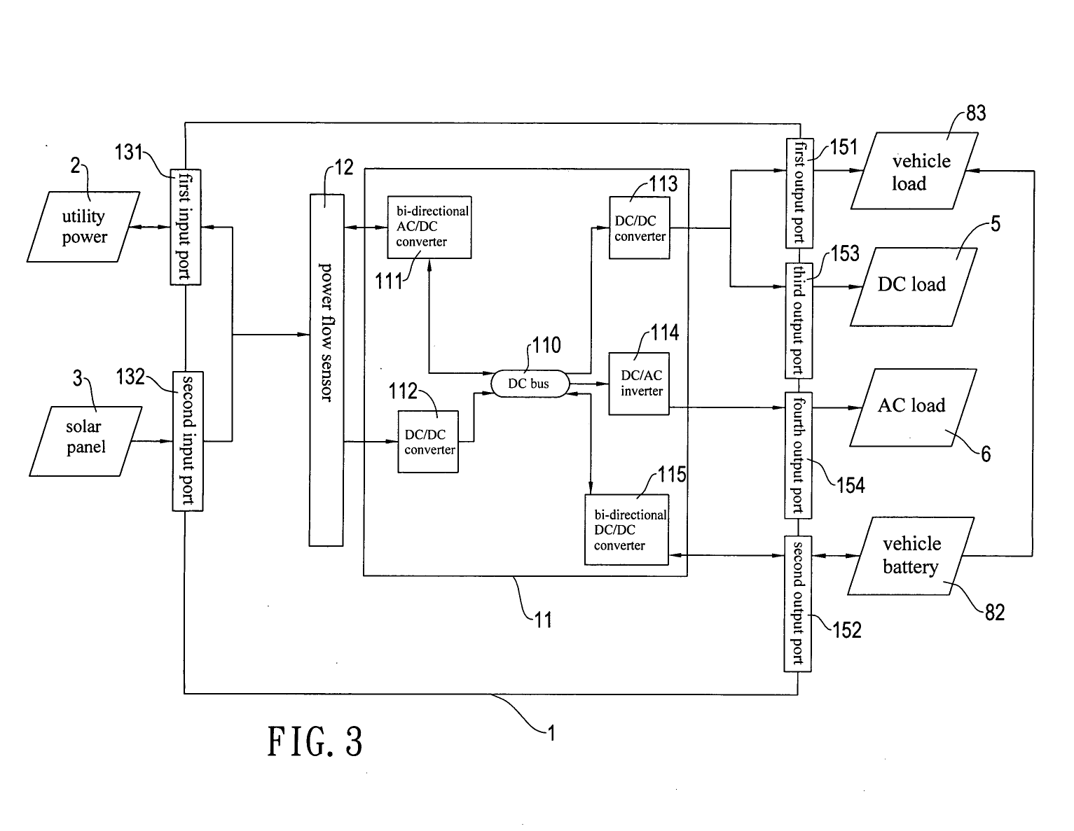

With reference to the drawings and in particular to FIGS. 1 and 3, the present invention provides a solar vehicle, generally designated at 8, comprising a vehicle body 81, at least one vehicle battery 82, a conversion device 1, and at least one solar panel 3.

The vehicle body 81 contains therein a vehicle load 83 for in-vehicle electronic appliances, which can be an in-vehicle television set, an in-vehicle multimedia player, a vehicle dashboard, or a vehicle driving device (vehicle motor).

The vehicle battery 82 is arranged inside the vehicle body 81 and the vehicle battery 82 is connected to the vehicle load 83 so that the vehicle battery 82 can supply electrical power to the vehicle load 83.

The conversion device 1 is also arranged inside the vehicle body 81. The conversion device 1 (see FIG. 3 for details) comprises a power flow sensor 12, first and second input ports 131, 132 for receiving inputs of electrical power, first and second output ports 151, 152 for supplying outputs of electrical power, and a conversion circuit 11 for conversion of the electrical power received from the input ports.

The conversion circuit 11 comprises a direct-current (DC) bus 110 (having an input side and an output side) and a plurality of converters (for example, converters, bi-directional converters, and inverters). The converters include a bi-directional AC (alternate-current)/DC converter 111 (such as a power supply) and a DC/DC converter 112 connected to the input side and a DC/DC converter 113, a DC/AC inverter 114, and a bi-directional DC/DC converter 115 connected to the output side.

The first input port 131 and the second input port 132 are both connected to the power flow sensor 12 and are further and respectively in connection with the bi-directional AC/DC converter 111 and the DC/DC converter 112 of the input side (in which the first input port 131 supplies electrical power to the bi-directional AC/DC converter 111 via the power flow sensor 12 and the second input port 132 supplies electrical power to the DC/DC converter 112 via the power flow sensor 12) so that the power flow received by the input ports can be detected and then fed to the conversion circuit 11 for carrying out power conversion. For example, the electrical power is first fed to the DC/DC converter 112 of the conversion circuit 11 for conversion into DC power for the DC bus 110, followed by further conversion operations carried out by the DC/DC converter 113, the DC/AC inverter 114, or the bi-directional DC/DC converter 115 for output. The DC/DC converter 113 and the bi-directional DC/DC converter 115 on the output side are respectively connected to the first and second output ports 151, 152. The first input port 131 can be connected to utility power 2 (such as electric mains or a power charging station).

The solar panel 3 is arranged on sun-facing surface of the vehicle body 81, which, in an embodiment of the present invention, includes a vehicle hood, a vehicle roof 811, or a trunk lid. (In the embodiment illustrated in FIG. 1, the solar panel 3 is arranged on the vehicle roof 811.) As shown in FIG. 1, the solar panel 3 is connected to the second input port 132 of the conversion device 1 (the second input port 132 being not shown in FIG. 1, but illustrated in FIG. 3) for supplying electrical power obtained from solar power generation thereto. The first and second output ports 151, 152 of the conversion device 1 are respectively connected to the vehicle load 83 and the vehicle battery 82 for individually supplying power thereto.

As such, the power received by the input ports 131, 132 is first subjected to conversion by the conversion circuit 11 and then output through the output ports 151, 152 (or also through output ports 153, 154) and the power flow sensor 12 functions to sense the power flow input from the input ports to automatically determine and select one or more of the input ports to supply electrical power to the conversion circuit 11, which electrical power, after being subjected to conversion by the conversion circuit 11, is supplied to the vehicle battery 82 to thereby realize continuous supply of power for ensuring being free of discontinuity of power supply and substantially enhance the cruising distance of vehicles.

The conversion device 1 may further comprise a third output port 153 and a fourth output port 154. The third and fourth output ports 153, 154 are respectively connected to the DC/DC converter 113 and the DC/AC inverter 114 of the output side. The third and fourth output ports 113, 114 are also connected to a DC load 5 and an AC load 6, respectively, for supplying the converted power to the DC load 5 and the AC load 6. In other words, the solar vehicle 8 of the present invention is capable to supply surplus power to for example a portable computer (which is considered a DC load) or a camping light (which is considered an AC load).

As such, the vehicle load (such as that for powering a vehicle driving device or in-vehicle electronics including an in-vehicle television set) can use the electrical power supplied from the vehicle battery 82. When the power level of the vehicle battery 82 is insufficient, electrical power from a power charging station or the electric mains can be connected and supplied to the first input port 131 and is then subjected to the conversions by the bi-directional AC/DC converter 111 and the bi-directional DC/DC converter 115, whereby the converted power is charged to the vehicle battery 82 via the second output port 152. When the in-vehicle television set, the in-vehicle multimedia player, the vehicle dashboard, except the vehicle driving device, are operated by the electrical power received from the solar panel 3, in case that the sun light is not intense enough or the weather becomes cloudy or raining, the power flow sensor 12 detects the insufficiency of power flow from the solar panel 3 and automatically switches or allows a user to manually switch to a condition of being completely operated by the vehicle battery 82 or, alternatively, switches to a condition of using electrical power supplied from the utility power system 2, instead of using the power from the solar panel 3; or when the vehicle driving device (vehicle motor) consumes less power, it can be switched to using the electrical power from the solar panel 3 and also allows a surplus portion of the electrical power from the solar panel 3 to be charged to the vehicle battery 82, so as to ensure continuous supply of power and eliminate the risk of discontinuity of power supply. Further, the solar vehicle 8 of the present invention is also capable to supply electrical power, via the conversion device 1, to other vehicles or automobiles, realizing road rescue of said other vehicles or automobiles.

FIG. 1 shows an arrangement of the solar panel 3 in accordance with the present invention, wherein the solar panel 3 is integrally formed with the roof 811 of the vehicle body 81.

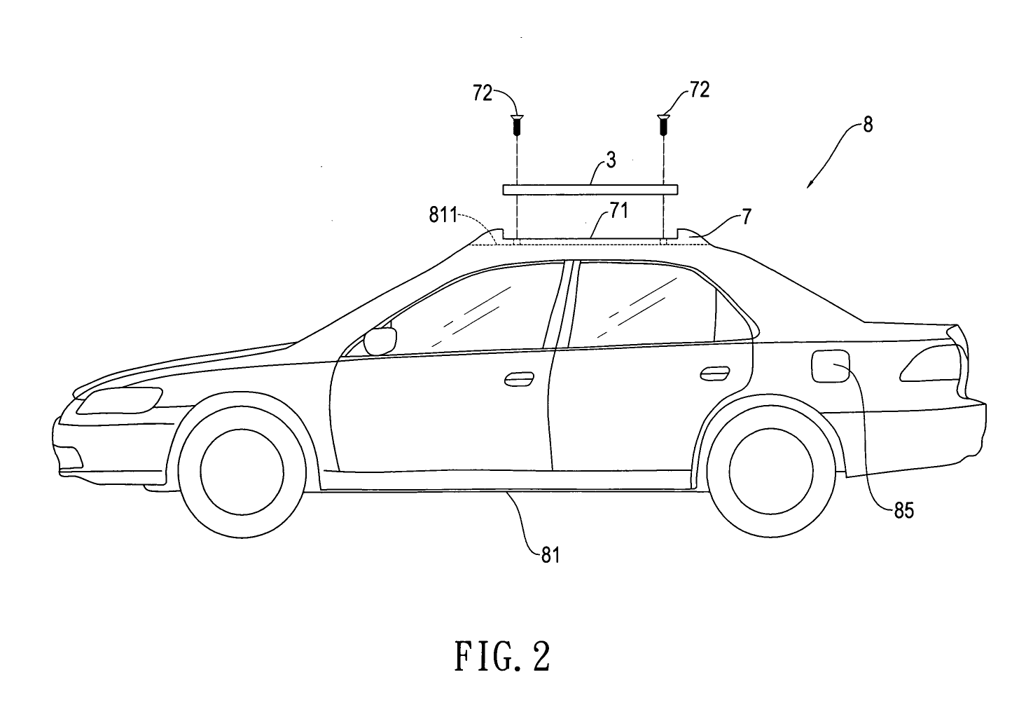

FIG. 2 shows another arrangement of the solar panel 3 in accordance with the present invention, wherein a retention device 7 is mounted to the roof 811 of the vehicle body 81. The retention device 7 comprises a receiving chamber 71 in which the solar panel 3 is removably received and detachably retained by a plurality of fasteners 72 so that the solar panel 3 can be fixed in the receiving chamber 71 of the retention device 7 in a detachable manner, by which detachable mounting of the solar panel 3 can be realized.

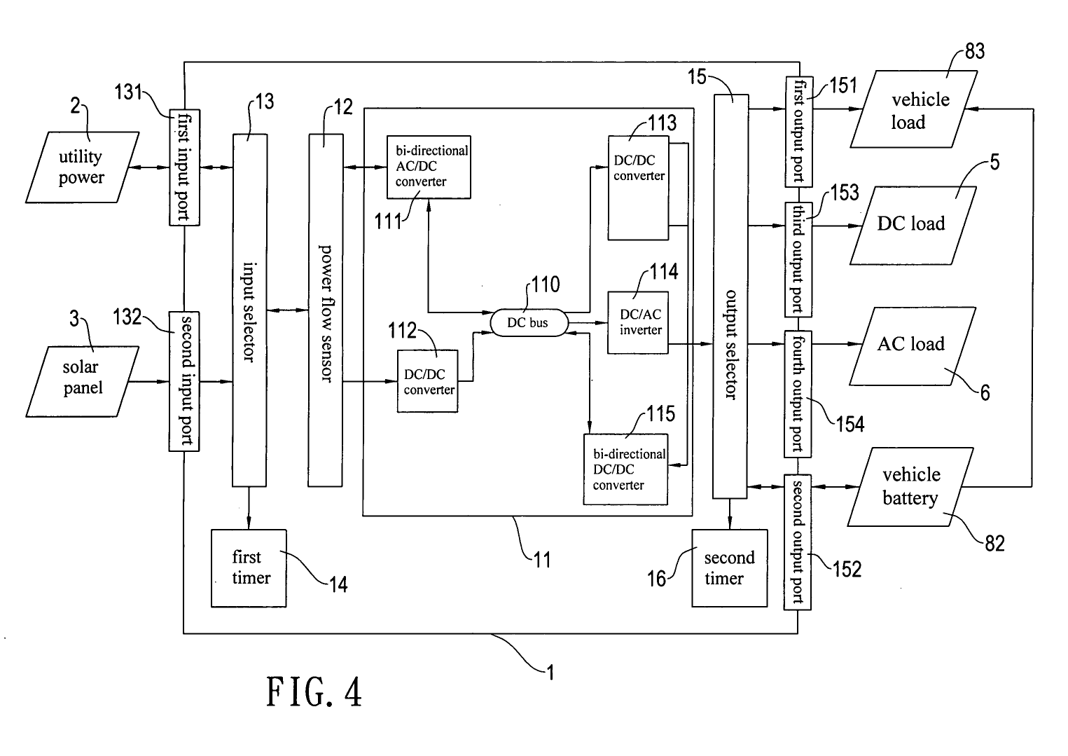

Reference is now made to FIG. 4, a second embodiment of the conversion device 1 of the present invention is shown, which further comprises an input selector 13, a first timer 14, an output selector 15, and a second timer 16.

The input ports 131, 132 are each connected to the input selector 13 and the input selector 13 is connected to the power flow sensor 12 whereby the input selector 13 bases on the input power flow detected by the power flow sensor 12 to select one or more of the input ports 131, 132 to receive input(s) of electrical power. The first timer 14 is connected to the input selector 13 to effect time-counting for power input, whereby the time when each input port 131, 132 inputs power is controlled on the basis of the first timer 14.

The output ports 151, 152, 153, 154 are each connected to the output selector 15. The converters 113, 114, 115 on the output side are commonly connected to the output selector 15 for selection of one or more of the output ports 151, 152, 153, 154 to output power. The second timer 16 is connected to the output selector 15 to effect time-counting for power output, whereby the time when each output port 151, 152, 153, 154 outputs power is controlled on the basis of the second timer 16.

In detail, the input selector 13 selects, among the input ports 131, 132, one or more input ports to receive electrical power in a period of time. For example, the selection can be made on the second input port 132 for receiving the electrical power generated by the solar panel 3 for one hour, which is counted by the first timer 14. The output selector 15 functions to select, among the output ports 151, 152, 153, 154, one or more output ports to output electrical power for a period of time. For example, the selection can be made on the first output port 151, which supplies electrical power to the vehicle load 83 for one hour, which is counted by the second timer 16. The input selector 13 and the output selector 15 are operated in accordance with the first timer 14 and the second timer 16 and respectively effect control over the input ports and output ports with respect to for example the input power amount and output power amount at preset time periods, or input target and output target, or input sequence and output sequence and so on. The preset time periods indicate the time in a day, the days in a week, or the seasons in a year. For example, in the daytime of summer, the priority of power input is the solar panel 3 (input target) connected to the second input port 132 and surplus power is first supplied for charging the vehicle battery 82 (output target) connected to the second output port 152, and then, in a lower priority, supplied to other output ports (output sequence). Or, in the nighttime, the power supplied is used, in a first priority, to energize vehicle headlights (output sequence). Or, in a specific given period of time, a specific input port is allowed to receive a given amount of power (input amount) or a specific output port is allowed to supply a given amount of power (output power). Or, it is possible to set that, for the days of a month, besides the holidays of the month, in a time period from 9 o'clock in the morning to 5 o'clock in the evening from Monday to Friday, which time period is considered an outdoor parking time period, the solar panel 3 that is connected to the second input port 132 is activated to charge the vehicle battery 82, whereby while a user of the vehicle is working in this or her office, the vehicle battery 82 is automatically charged for replenishing the power that has been used during the rush hours when he or she drives to the office or back to home.

In addition, referring to FIG. 3 (or FIG. 4), the first input port 131 of the conversion device 1 can be made to supply power to an external device, which is realized by two ways, the first one being that the power generated by the solar panel 3 is fed sequentially through the second input port 132 (or further through the input selector 13 for the embodiment illustrated in FIG. 4), the power flow sensor 12, the DC/DC converter 112, the DC bus 110, the bi-directional AC/DC converter 111, the power flow sensor 12 (or further through the input selector 13 of the embodiment illustrated in FIG. 4), and the first input port 131 to the utility power 2. By coupling the first input port 131 with the electricity network of the utility power system, the electrical power can be supplied to an outlet socket in the system of the utility power 2. The second way is to supply electrical power from the vehicle battery 82, which flows sequentially through the second output port 152 (or further through the output selector 15 for the embodiment illustrated in FIG. 4), the bi-directional DC/DC converter 115, the DC bus 110, the bi-directional AC/DC converter 111, the power flow sensor 12 (or further through the input selector 13 of the embodiment illustrated in FIG. 43), and the first input port 131 to supply to the system of the utility power 2. By coupling the first input port 131 with the electricity network of the utility power system 2, the electrical power can be supplied to an outlet socket in the system of the utility power 2.

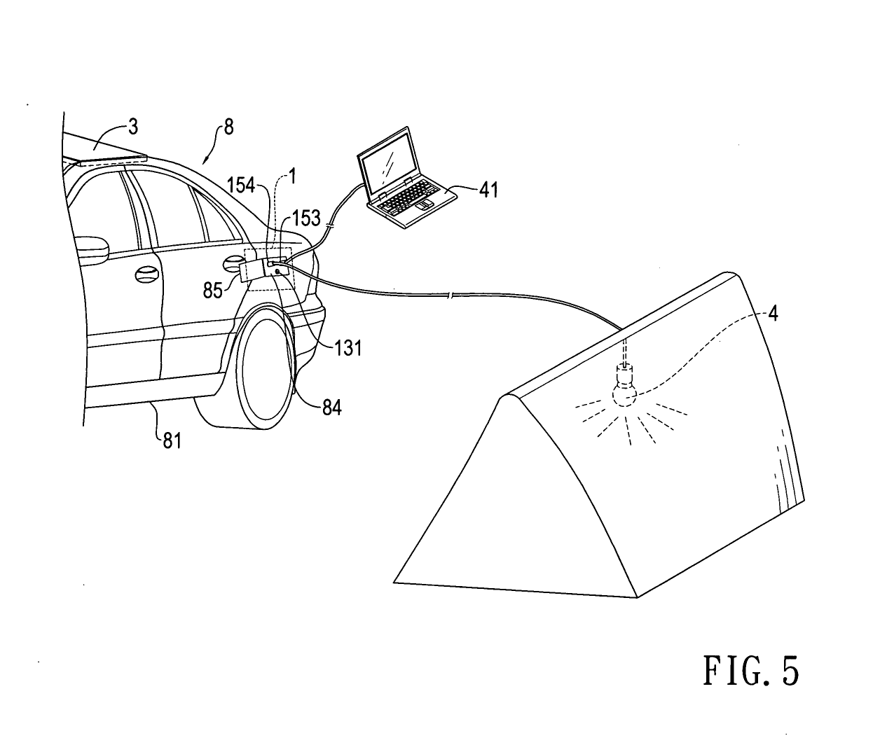

Reference is now made to FIG. 5, which illustrates an arrangement for supplying electrical power from an output port in accordance with the present invention. The vehicle body 81 of the solar vehicle 8 in accordance with the present invention forms an opening 84 and a cover 85 selectively closing the opening 84. The opening 84 is set to correspond in position to the conversion device 1. The input ports (such as the first input port 131) and the output ports (such as the third and fourth output ports 153, 154) can be exposed and accessed through the opening 84. The cover 85 is movably mounted to the vehicle body 81 (such as by means of a pivotal joint as illustrated in FIG. 5, or alternatively by means of a slide cover arrangement). In other words, the cover 85 can be opened to expose the input ports and the output ports and the cover 85 can also be closed to cover the input ports and the output ports. In FIG. 5, it only needs to open the cover 85 in order to access and use the fourth output port 154 of the conversion device 1 to supply electrical power to a camping light 4 (or a mower that is not illustrated in the drawings), or to use the third output port 153 to supply electrical power to a portable computer 51. This is really very convenient.

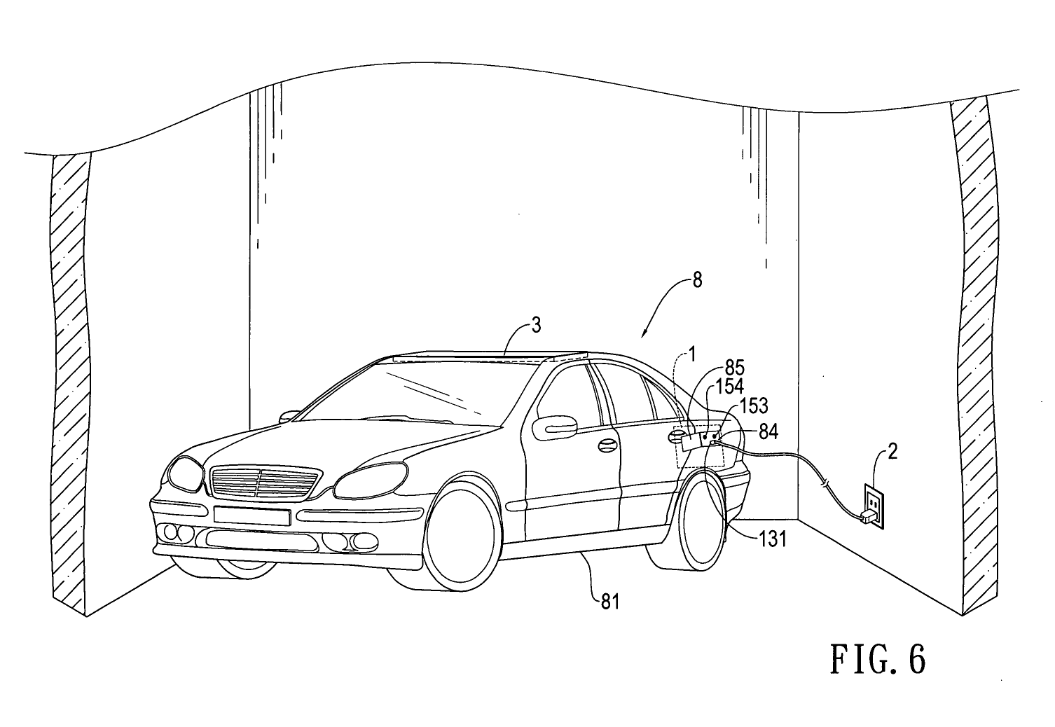

Also referring to FIG. 6, which illustrates an arrangement of using the input port to effect charging operation in accordance with the present invention. With the cover 85 of the solar vehicle 8 opened, the first input port 131 can be accessed and connected to the utility power system 2 (such as connected to a wall outlet that is provided in a garage), whereby the electrical power obtained from the utility power system 2 can be fed to and converted by the conversion circuit 11 for supply through the second output port 152 to charge the vehicle battery 82 and this is very convenient.

The solar vehicle of the present invention features that with a sun-facing surface of the vehicle body 81 being provided with a solar panel 3, a conversion device 1 is arranged inside the vehicle body 81 and connected to the solar panel 3 and the conversion device 1 is further connected to a vehicle battery 82 and a vehicle load 83, and the conversion device 1 is comprised of multiple input ports 131, 132, multiple output ports 151, 152, 153, 154 and a power flow sensor 12, the vehicle battery 82 and the vehicle load 83 being connected to each other, whereby determination can be automatically made to allow one or more of various power sources to provide electrical power to the solar vehicle 8 to ensure continuous supply of power and eliminate interruption of power supply so as to enhance the cruising distance of the vehicle and even provide surplus power for other uses, such as powering camp light 4, portable computer 41 or for supplying power to other vehicles for road rescue. With the input and output ports of the conversion device 1 are set at locations corresponding to the opening 84, once the cover 85 is opened, supplying of power to the camp light 4, the portable computer 41 or other vehicles for road rescue can be immediately carried out. The conversion device 1 of the present invention, with the addition of an input selector 13, an output selector 15 and first and second timers 14, 16, provides a feature of automatically selecting a specific input port for receiving power input and automatically selecting a specific output port to which power is supplied, and controls of the input power amount, the output power amount, the output target, the input target, the output sequence and the input sequence of the input and output ports. As such, the present invention is of practicability and convenience.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A solar vehicle, comprising:
a vehicle body, which contains therein a vehicle load for in-vehicle electronic appliances;
at least one vehicle battery, which is arranged inside the vehicle body and is connected to the vehicle load for supplying electrical power thereto;
a conversion device, which is arranged inside the vehicle body, comprising first and second input ports for receiving inputs of electrical power, first and second output ports for supplying outputs of electrical power, a conversion circuit for conversion of the electrical power received by the input ports, and a power flow sensor, wherein the conversion circuit comprises a direct-current (DC) bus having an input side and an output side, a bi-directional AC (alternate-current)/DC converter and a DC/DC converter connected to the input side, and a DC/DC converter, a DC/AC inversion converter, and a bi-directional DC/DC converter connected to the output side; wherein the second input port and the first input port, which is adapted to connect to a utility power system, are both connected to the power flow sensor and are further and respectively in connection with the DC/DC converter and the bi-directional AC/DC converter of the input side so that power flows received by the input ports can be detected and then fed to the conversion circuit for power conversion; and wherein the DC/DC converter and the bi-directional DC/DC converter on the output side are respectively connected to the first and second output ports; and
a solar panel, which is arranged on a sun-facing surface of the vehicle body and is connected to the second input port of the conversion device to supply electrical power obtained from solar power generation thereto, the first and second output ports of the conversion device being respectively connected to the vehicle load and the vehicle battery for supplying power thereto;
whereby electrical power received by the input ports is first subjected to conversion by the conversion circuit and then output through the output ports and whereby the power flow sensor detects a power flow from the input ports to automatically determine and select one or more of the input ports to supply electrical power to the conversion circuit, which electrical power, after being subjected to conversion by the conversion circuit, is supplied to the vehicle battery.

2. The solar vehicle as claimed in claim 1, wherein the solar panel is arranged on a roof of the vehicle body.

3. The solar vehicle as claimed in claim 1, wherein the vehicle body has a roof on which a retention device is mounted, the retention device forming a receiving chamber in which the solar panel is removably received, the solar panel and the retention device being fixed together by means of a plurality of removable fasteners.

4. The solar vehicle as claimed in claim 1, wherein the vehicle body forms an opening and a cover selectively closing the opening, the opening being set to correspond in position to the conversion device, the input ports and the output ports being selectively exposed and accessible through the opening, the cover being movably mounted to the vehicle body, wherein the cover is openable to expose the input ports and the output ports and the cover is closable to cover the input ports and the output ports.

5. The solar vehicle as claimed in claim 1, wherein the conversion device further comprise a third output port and a fourth output port, the third and fourth output ports being respectively connected to the DC/DC converter and the DC/AC inverter of the output side, the third and fourth output ports being adapted to connect to a DC load and an AC load, respectively, for supplying electrical power to the DC load and the AC load.

6. The solar vehicle as claimed in claim 1, wherein the conversion device further comprises an input selector and a first timer, wherein the input ports are each connected to the input selector and the input selector is connected to the power flow sensor, whereby the input selector bases on input power flow detected by the power flow sensor to select one or more of the input ports to receive the input of electrical power, and wherein the first timer is connected to the input selector to effect time-counting for the power input, whereby the time when each input port inputs power is controlled on the basis of the first timer.

7. The solar vehicle as claimed in claim 6, wherein the time-counting carried out by the first timer includes time in a day, days in a week, and seasons in a year.

8. The solar vehicle as claimed in claim 7, wherein the time-counting carried out the first timer includes a period of time.

9. The solar vehicle as claimed in claim 1, wherein the conversion device further comprises an output selector and a second timer, wherein the output ports are each connected to the output selector and the output side converters are commonly connected to the output selector for selection of one or more of the output ports to supply the output of electrical power, and wherein the second timer is connected to the output selector to effect time-counting for power output, whereby the time when each output port outputs power is controlled on the basis of the second timer.

10. The solar vehicle as claimed in claim 9, wherein the time-counting carried out by the second timer includes time in a day, days in a week, and seasons in a year.

11. The solar vehicle as claimed in claim 10, wherein the time-counting carried out the second timer includes a period of time.

12. The solar vehicle as claimed in claim 1, wherein the conversion device further comprises an input selector, a first timer, an output selector, and a second timer, wherein the input ports are each connected to the input selector and the input selector is connected to the power flow sensor, whereby the input selector bases on input power flow detected by the power flow sensor to select one or more of the input ports to receive the input of electrical power, the first timer being connected to the input selector to effect time-counting for power input, whereby the time when each input port inputs power is controlled on the basis of the first timer, and wherein the output ports are each connected to the output selector and the output side converters are commonly connected to the output selector for selection of one or more of the output ports to supply the output of electrical power, the second timer being connected to the output selector to effect time-counting for power output, whereby the time when each output port outputs power is controlled on the basis of the second timer.

13. The solar vehicle as claimed in claim 12, wherein the time-counting carried out by the first and second timers includes time in a day, days in a week, and seasons in a year.

14. The solar vehicle as claimed in claim 13, wherein the time-counting carried out the first and second timers includes a period of time.
